(19) United States
(12) Patent Application Publication
(10) Pub. No.: US 2013/0104723 A1
(43) Pub. Date: May 2, 2013

(54) Mouthpiece for Brass-Wind Musical Instrument

(71) Applicant: David Bruce Griffin, Toccoa, GA (US)

(72) Inventor: David Bruce Griffin, Toccoa, GA (US)

(21) Appl. No.: 13/283,751

(22) Filed: Oct. 28, 2011

(51) Int. Cl. G10D 9/02

(52) U.S. Cl. 84/398

(57) ABSTRACT

A mouthpiece for a musical instrument is provided that includes an upper section. A cup is at least partially defined by the upper section. The upper section has a rim that has an end face. The rim has an outer perimeter that has a major axis and a minor axis. The major axis of the outer perimeter of the rim is greater in length than the minor axis of the outer perimeter of the rim.

### FIELD OF THE INVENTION

The present invention relates generally to a mouthpiece for use with brass-wind musical instruments. More particularly, the present application involves a mouthpiece that may have a rim with a concave shaped end face, an oval shaped outer perimeter, a rim width with a flat shaped end face, and/or a cup with an oval shaped outer perimeter.

### BACKGROUND

Musical instruments, such as brass instruments, include a mouthpiece which is the portion of the instrument to which the musician places his or her lips. The mouthpiece is responsible for a large portion of the resulting sound the instrument makes when performing. The typical mouthpiece includes a rim with a convex terminal end that is the surface the lips of the user actually contact. The mouthpiece defines a bore that extends completely through from one end to the other. A cup is provided in the mouthpiece that is cone shaped and transitions to a throat portion that is smaller in diameter. A backbore extends through a shank of the mouthpiece that defines the lower end of the mouthpiece.

The cup of the mouthpiece can have either a semi-spherical shape or a conical shape. The shape of the cup may have an effect on the tone that is ultimately projected. A semi-spherical shaped cup may produce a tone with more definition than a cup that is conical in shape. Further, the depth of the cup has an effect on the range of tone that can be generated by the instrument. It is also known to vary the width of the rim of a mouthpiece in order to change how the mouthpiece will perform. A rim that is wide reduces the amount of pressure that the musician needs to apply to the mouthpiece thus increasing the amount of time the musician can perform by decreasing his or her strain in playing the instrument. However, increasing the width of the rim reduces the ability of the musician to produce different sounds with the mouthpiece.

One modification of a mouthpiece for brass instruments involves the provision of a counter bore located between the throat and the backbore. The throat is a generally narrow passage and the counter bore is wider than the throat such that the air-flow path extending through the mouthpiece widens upon exiting the throat and entering the counter bore. From the counter bore, the air-flow path extends into the backbore of the mouthpiece. This arrangement is said to amplify sounds prior to entering the backbore so that the musician can achieve higher notes with increased ease while maintaining the same feel of a conventional mouthpiece.

Another variation of mouthpiece design seeks to achieve a mouthpiece that is physically easier to play by the user and reduces the difficulty of high-register playing. This mouthpiece design includes an asymmetric lip restrictor that is in the form of a convex surface located within the cup. The user will attach the mouthpiece to the instrument so that the convex surface is positioned at the bottom lip of the user during use. The upper portion of the cup does not include the convex surface.

Although various attempts at improving the performance of mouthpieces used on brass instruments have been made, there still remains a need for a mouthpiece that reduces strain on the embouchure and is easier for the user to play. As such, there remains room for variation and improvement within the art.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended Figs in which:

FIG. 1 is a front elevation view of a mouthpiece in accordance with one exemplary embodiment.

FIG. 2 is a side elevation view of the mouthpiece of FIG. 1.

FIG. 3 is a top view of the mouthpiece of FIG. 1.

FIG. 4 is a top view of the mouthpiece of FIG. 1 that illustrates different reference numbers from those illustrated in FIG. 3.

FIG. 5 is a cross-sectional elevation view taken along line 5-5 of FIG. 2.

FIG. 6 is a cross-sectional elevation view taken along line 6-6 of FIG. 1.

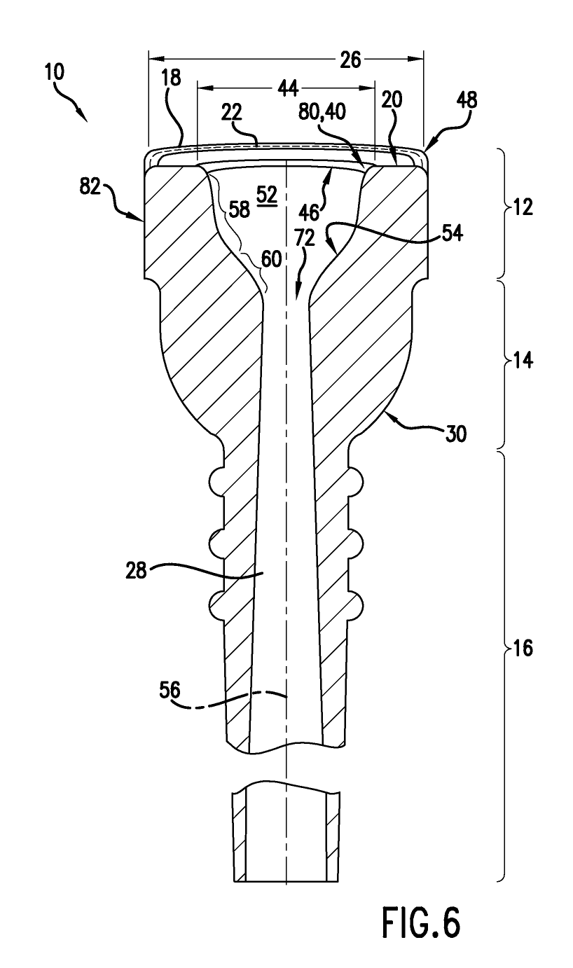

FIG. 7 is a cross-sectional view taken along line 7-7 of FIG. 1.

FIG. 8 is a cross-sectional view taken along line 8-8 of FIG. 1.

FIG. 9 is a cross-sectional view taken along line 9-9 of FIG. 1.

Repeat use of reference characters in the present specification and drawings is intended to represent the same or analogous features or elements of the invention.

### DETAILED DESCRIPTION OF REPRESENTATIVE EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to 7 also includes a limit of up to 5, up to 3, and up to 4.5.

The present invention provides for a mouthpiece 10 that may be used with brass instruments in order to play music. The mouthpiece 10 may be arranged so that the musician may reach higher notes even if he or she lacks the normal embouchure to do so. The mouthpiece 10 may be easier to use, may increase comfort on the musician's lips, and may reduce fatigue on his or her embouchure. A cup 52 that can be oval in shape may be included in the mouthpiece 10 in some embodiments, along with a rim 18 that has an oval shaped outer perimeter 18. In other embodiments, the mouthpiece 10 may include a rim 18 with an end face 20 that is concave in shape. Still further arrangements of the mouthpiece exist in which the width 50 of the end face 20 of the rim 18 is flat in shape upon extending from a round 48 of an outer perimeter 22 to a round 46 of an inner perimeter 40 of the rim 18.

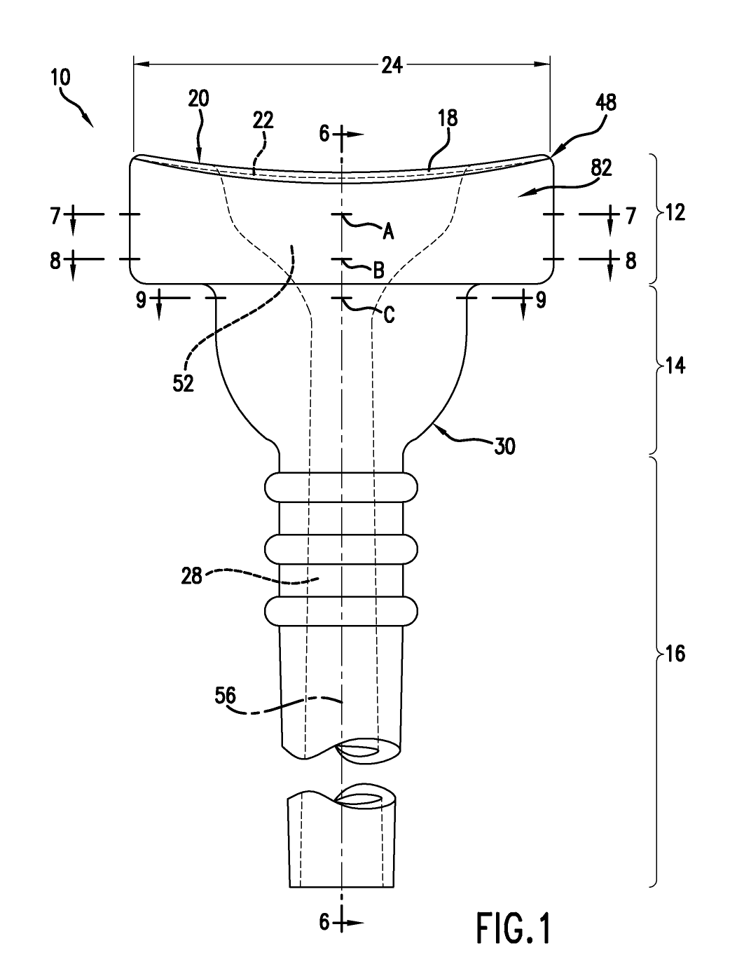

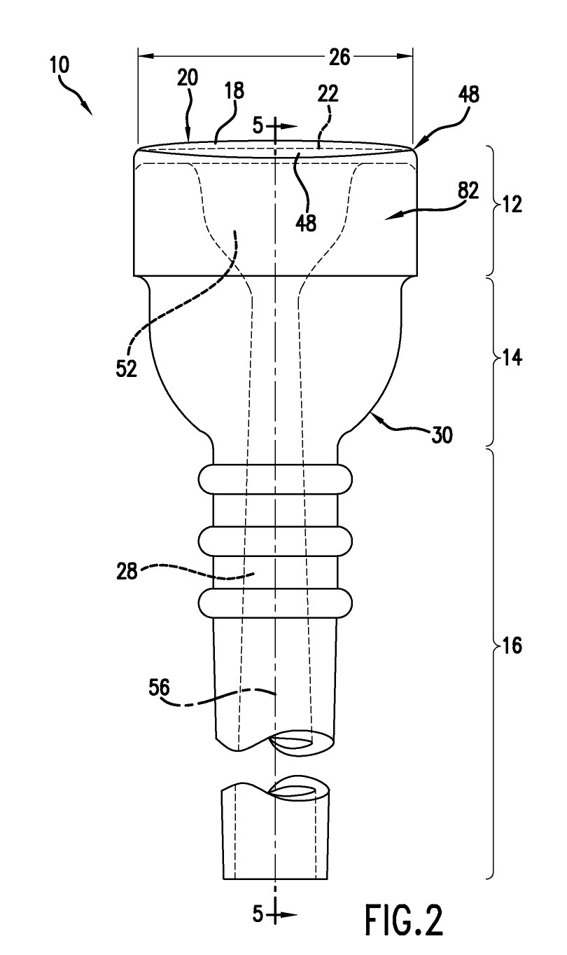

One exemplary embodiment of the mouthpiece 10 is disclosed in FIG. 1. The mouthpiece 10 may be a single, integrally formed piece, or may be a plurality of components that are attached to one another. For purposes of discussion, the mouthpiece 10 has an upper section 12 that is the portion of the mouthpiece 10 that engages the lips of the musician during use. A middle section 14 of the mouthpiece 10 extends from the upper section 12, and a lower section 16 in turn extends from the middle section 14 and is the portion of the mouthpiece 10 farthest from the lips of the user during use. With reference to FIGS. 1-3, the upper section 12 includes a rim 18 that has an end face 20 that forms the upper, terminal end of the mouthpiece 10. The mouthpiece 10 may be made of any type of material such as yellow brass, stainless steel, titanium, plastic, or LEXAN® available from Sabic Innovative Plastics having offices located at One Plastics Avenue, Pittsfield, Mass., 01201, USA.

The rim 18 has an outer perimeter 22 that marks the boundary between the rim 18 and an exterior side wall 82 of the mouthpiece 10. As the lips of the user may engage the rim 18, it is normally the case that a round 48 is located on the perimeter 22 to prevent the presence of a sharp edge that may cut or injure the lips of the user during use. The round 48 may extend along the entire perimeter 22, or may extend only partially around the full length of the perimeter 22 in accordance with various exemplary embodiments. The perimeter 22 may be located at the middle of the round 48, or may be located immediately inboard (on the side towards the longitudinal axis 56) of the round 48, or may be located immediately outboard (on the side of round 48 farthest away from the longitudinal axis 56) of the round 48 in various embodiments.

The outer perimeter 22 may have a major axis 24 and a minor axis 26. The outer perimeter 22 may also have a first major axis side 32 and an oppositely located second major axis side 34. The first major axis side 32 is located between points 84 and 88, and the second major axis side 34 is located between points 86 and 90. The first major axis 24 extends from the first major axis side 32 to the second major axis side 34. The remaining sides of the outer perimeter 22 can be defined as a first minor axis side 36 that is located between points 84 and 86, and a second minor axis side 38 that is located between points 88 and 90. A minor axis 26 extends from the first minor axis side 36 to the second minor axis side 38. Both the major axis 24 and minor axis 26 extend through the longitudinal axis 56.

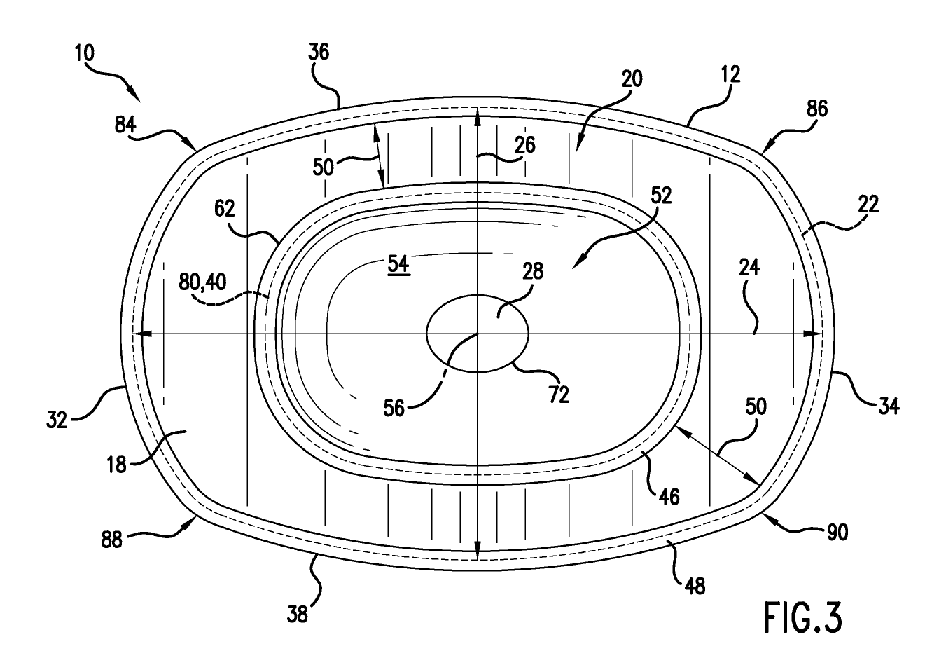

The outer perimeter 22 of the rim 18 may be configured so that the major axis 24 is longer in length than the minor axis 26. This arrangement can be made so that the outer perimeter 22 of the rim 18 is oval shaped. In other exemplary embodiments, the outer perimeter 22 may be oval in shape and the oval may be an ellipse. In some embodiments, the major axis 24 may be 1.25 times, 1.5 times, 1.75 times, 2 times, or up to 10 times longer than the minor axis 26. The outer perimeter 22 may be arranged so that any one or all of the sides 32, 34, 36, and/or 38 are straight or curved. As shown in FIG. 3, all of the sides 32, 34, 36 and 38 have some amount of curvature. It is to be understood that other exemplary embodiments of the mouthpiece 10 exist in which the major axis 24 and the minor axis 26 are of the same length such that the outer perimeter 22 is circular in shape. The outer perimeter 22 may be square shaped or rectangular shaped in accordance with yet other exemplary embodiments.

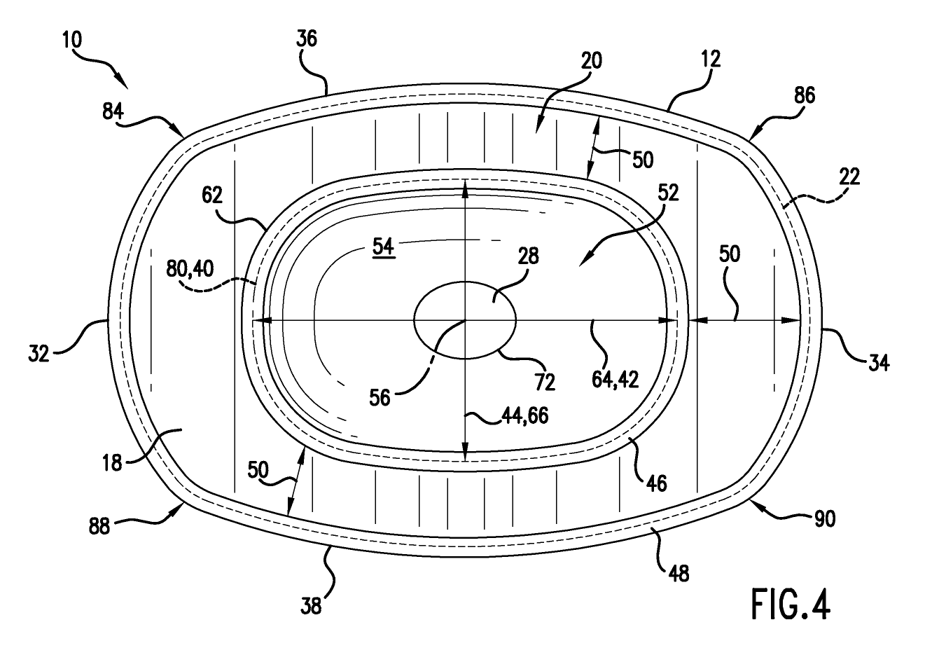

The end face 20 of the rim 18 extends from the outer perimeter 22 to an inner perimeter 40. As such, the end face 20 may be defined between the perimeters 22 and 40. Particulars of the inner perimeter 40 may be described with reference to FIG. 4. As the user may engage the inner perimeter 40 with his or her lips, a round 46 may be located along the entire length of the inner perimeter 40 to eliminate sharp edges. The round 46 may extend along the entire length of the inner perimeter 40 or only along a portion of the length of the inner perimeter 40 in various embodiments. The inner perimeter 40 may be located so that it is in the middle of the round 46, immediately adjacent the round 46 on the side of the round 46 closest to the longitudinal axis 56, or immediately adjacent the round 46 on the side of the round 46 that is farthest from the longitudinal axis 56.

The inner perimeter 40 can be variously shaped. In the embodiment shown, the inner perimeter 40 has a major axis 42 that is coincident with the major axis 24 along a portion of its length. The inner perimeter 40 also includes a minor axis 44 that is coincident with the minor axis 26 along a portion of its length. Both the major axis 42 and the minor axis 44 extend through the longitudinal axis 56 of the mouthpiece 10 and are located at a right angle to one another. The major axis 42 may be sized so that it is longer than the minor axis 44. The major axis 42 may be from 1.25 times, 1.5 times, 1.75 times, 2 times, or up to 10 times longer than the minor axis 44. The proportional differences in length between the axes 24 and 26 of the outer perimeter 22 may be the same as or different from the proportional difference in length between the axes 42 and 44. The inner perimeter 40 can be arranged so that all of the sides of the inner perimeter 40 are curved. Alternatively, some of the sides may be curved and the others straight, and still further, all of the sides of the inner perimeter 40 may be straight in accordance with other exemplary embodiments. The inner perimeter 40 may be arranged so that it is oval in shape. In some embodiments, the inner perimeter 40 may be an oval in shape and may also be elliptical in shape. In other exemplary embodiments, the inner perimeter 40 may be square or rectangular in shape.

The end face 20 can be arranged so that it lacks a convex portion at certain locations. With reference to FIGS. 3 and 4, a width 50 of the end face 20 is defined so that it extends from the round 46 to the round 48. The width 50 may be the portion of the end face 20 that extends from a point immediately adjacent the round 46 at the side of round 46 farthest from the longitudinal axis 56 to a point immediately adjacent the round 48 that is closest to the longitudinal axis 56, such that the line of the width 50 would if extended extend through the longitudinal axis 56. The width 50 may be flat. Further, the width 50 may lack a convex portion. In this regard, absent the rounds 46 and 48, the entire end face 20 may lack a convex portion. Various widths 50 are noted in FIGS. 3 and 4, but it is to be understood that additional widths 50 are present and may be arranged 360° around the longitudinal axis 56. Although described as lacking a convex shape, other embodiments of the mouthpiece 10 may have an end face 20 that has one or more convex shaped portions. In this regard, the width 50 may be convex in shape. Still further, the entire end face 20 surrounding the longitudinal axis 56 may be convex in shape in accordance with other exemplary embodiments. The width 50 may be variously sized, as with all other features of the mouthpiece in accordance with other exemplary embodiments. For example, the width 50 may be from 0.01-1 millimeter, from 0.5-2 millimeters, from 1-4 millimeters, or up to 12 millimeters in accordance with various exemplary embodiments.

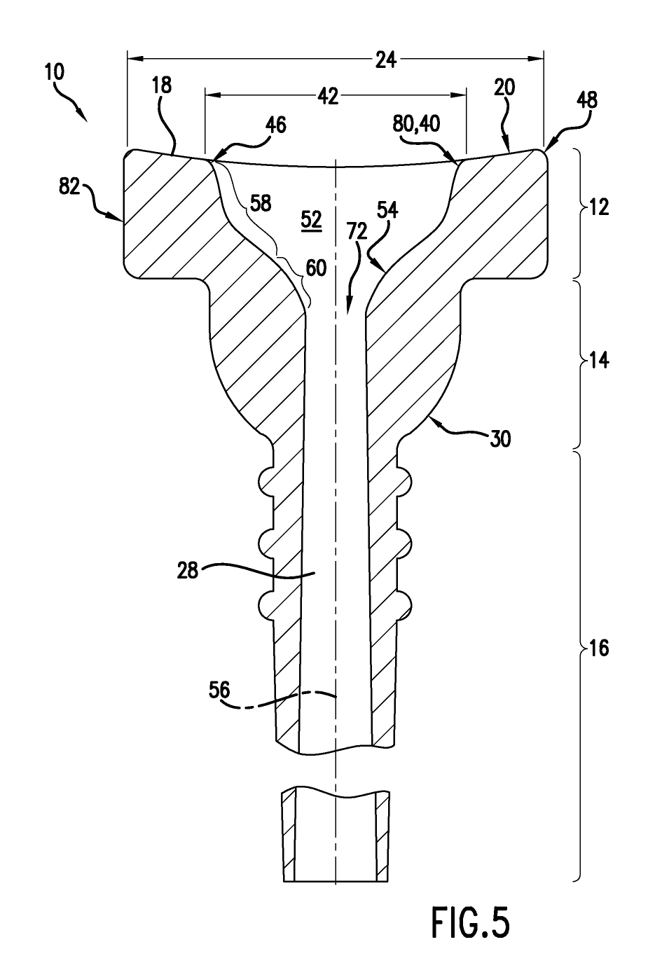

The end face 20 may be configured so that it has a concave shape upon extension from the first major axis side 32 to the second major axis side 34. This concave shape may be more easily seen with reference to FIG. 1 in which the end face 20 reaches a low point at the longitudinal axis 56 and reaches two high points on either end. With reference back to FIG. 3, the low point of the end face 20 may be at the minor axis 26 while the high point is at both the first and second major axis sides 32 and 34. The end face 20 can be concave in shape so that it is completely symmetric about the minor axis 26, and completely symmetric about the major axis 24. The concave portion of the end face 20 may be the entire end face 20 except for any portions of the rounds 46 and 48 that are located in the end face 20. With reference to the cross-sectional view of FIG. 5, the concave shape of the end face 20 may be seen, along with the flat shape of the end face 20 with respect to the width 50 of the end face 20. In other embodiments, the end face 20 need not have a concave shape, or only a portion of the end face 20 may have a concave shape while other portions of the end face 20 do not have a concave shape.

The mouthpiece 10 may also feature a cup 52 that can be defined by an inner surface 54 of the mouthpiece 10. The cup 52 may be located in the upper section 12 and the middle section 14. It is to be understood that the cup 52 may be located in only the upper section 12, in only the upper and middle sections 12 and 14, or in all of the sections 12, 14 and 16 in accordance with various exemplary embodiments. In embodiments in which the mouthpiece 10 lacks a middle section 14, the cup 52 need not be located in a middle section 14. The cup 52 may be located in any section of the mouthpiece 10 even if such mouthpiece 10 lacks a particular section or has no sections at all. The depth of the cup 52 may be the distance the cup 52 extends in the longitudinal direction along the longitudinal axis 56 from the upper end 80 to the throat 72. The depth of the cup 52 may be varied in accordance with different exemplary embodiments. For example, the cup 52 may have a depth from 0.5-1 millimeter, from 1-10 millimeters, or up to 30 millimeters in accordance with various embodiments.

The cup 52 has an upper end 80 that is located at the same point as the inner perimeter 40 as shown with reference to FIG. 4. The upper end 80 may be coincident with the inner perimeter 40 such that these two features are essentially a single feature and have the same size and shape as one another. It is to be understood that as used herein, the term “coincident” may mean two features that share the exact same size and location, or it may be the case that one feature such as a line is included within another feature such as a different line that is longer than the first line. The term thus means two features that make up essentially one feature, or two features one of which forms part of a second. The upper end 80 demarcates the boundary between the rim 18 and the cup 52 and the round 46 can be located at the upper end 80 so that the user does not injure his or her lips during use. The upper end 80 may be located in the middle of this round 46 or may be on either side of the round 46 in other embodiments. Further, it is to be understood that the rounds 46 and/or 48 need not be present in accordance with various exemplary embodiments.

The upper end 80 of the cup 52 may thus define a perimeter 62 of the cup 52 which is located at the same location as the inner perimeter 40. The perimeter 62 may have a major axis 64 and a minor axis 66. The perimeter 62 can be variously shaped. The major axis 64 may be coincident with the major axis 24 along a portion of its length, and the minor axis 66 may be coincident with the minor axis 26 along a portion of its length. Both the major axis 64 and the minor axis 66 extend through the longitudinal axis 56 of the mouthpiece 10 and are located at a right angle to one another. The major axis 64 may be sized so that it is longer than the minor axis 66. The major axis 64 may be from 1.25 times, 1.5 times, 1.75 times, 2 times, or up to 10 times longer than the minor axis 66. The perimeter 62 can be arranged so that all of the sides of the perimeter 62 are curved. Alternatively, some of the sides may be curved and the others straight, and still further, all of the sides of the perimeter 62 may be straight in accordance with other exemplary embodiments. The perimeter 62 may be arranged so that it is oval in shape. In some embodiments, the perimeter 62 may be an oval in shape and may also be elliptical in shape. In other exemplary embodiments, the perimeter 62 may be square or rectangular in shape.

The cup 52 extends downward from the upper end 80 in the direction along the longitudinal axis 56. The cup 52 may be discussed in relation to an upper section 58 of the cup 52, and a lower section 60 of the cup 52. The cup 52 terminates at a throat 72 of the mouthpiece 10 that can be located in either the middle section 14, the lower section 16, or may be the point of demarcation between the middle section 14 and lower section 16. Again, it is to be understood that the throat 72 need not be located at a section of the mouthpiece 10, or may be located in a section different from that previously mentioned in other exemplary embodiments of the mouthpiece 10. The throat 72 may simply be the opening of the backbore 28 and thus have essentially no length in the longitudinal direction along the longitudinal axis 56. Alternatively, the throat 72 may extend some length in the longitudinal direction along the longitudinal axis 56 from the bottom end of the cup 52 and at some point the throat 72 transitions to the backbore 28 such that this transition can be physically noted upon inspection of the mouthpiece 10 or such that this transition does not have a physical point/line/boundary of demarcation.

The lower section 60 of the cup 52 may extend from the throat 72 to the upper section 58. In turn, the upper section 58 may extend from the lower section 60 to the upper end 80. There need not be a physical boundary line or clear line of distinction between the upper section 58 and the lower section 60. In some embodiments, the size of the cup 52 may become noticeably smaller at a certain point, and this certain point may mark the boundary between the upper section 58 and the lower section 60. However, in yet other arrangements, the size of the cup 52 may decrease/increase gradually or not radically in the longitudinal direction such that no clear boundary line between an upper section 58 and a lower section 60 may be noticed. In such arrangements, the cup 52 may still be thought of as having an upper section 58 and lower section 60 although there is no clear physical boundary marker separating these sections. The perimeter 62 in the lower section 60 may be in some instances larger than the perimeter 62 in the upper section 58. In other arrangements, the perimeter 62 in the lower section 60 may be the same size or smaller than the perimeter 62 of the upper section 58. The perimeter 62 in the upper section 58 may have an oval shape while the perimeter 62 in the lower section 60 has a conical or semi-spherical shape. In other exemplary embodiments, the perimeter 62 in both the upper section 58 and the lower section 60 has an oval shape.

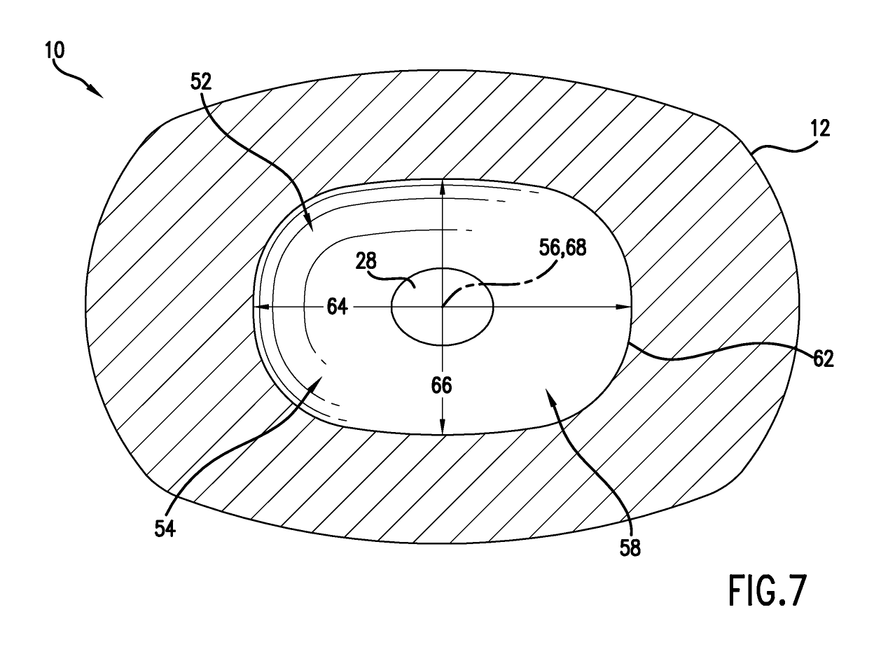

FIG. 7 is a cross-sectional view taken along line 7-7 of FIG. 1 that illustrates the cup 52 in an upper section 58 of the cup 52. The cup 52 is symmetrical and is defined by the inner surface 54 so as to have a perimeter 62. The perimeter 62 includes a major axis 64 and a minor axis 66. The axes 62 and 64 intersect one another at a point of intersection A 68 that is located on the longitudinal axis 56. The axes 62 and 64 may be arranged as previously discussed and a repeat of this information is not necessary. The major axis 64 may be longer than the minor axis 66, and the perimeter 62 can have an oval shape. In certain embodiments, the perimeter 62 may be oval shaped and elliptical shaped. In other embodiments, the perimeter 62 of the cup 52 may be circular in shape at all locations, or at some of the locations along the longitudinal axis 56.

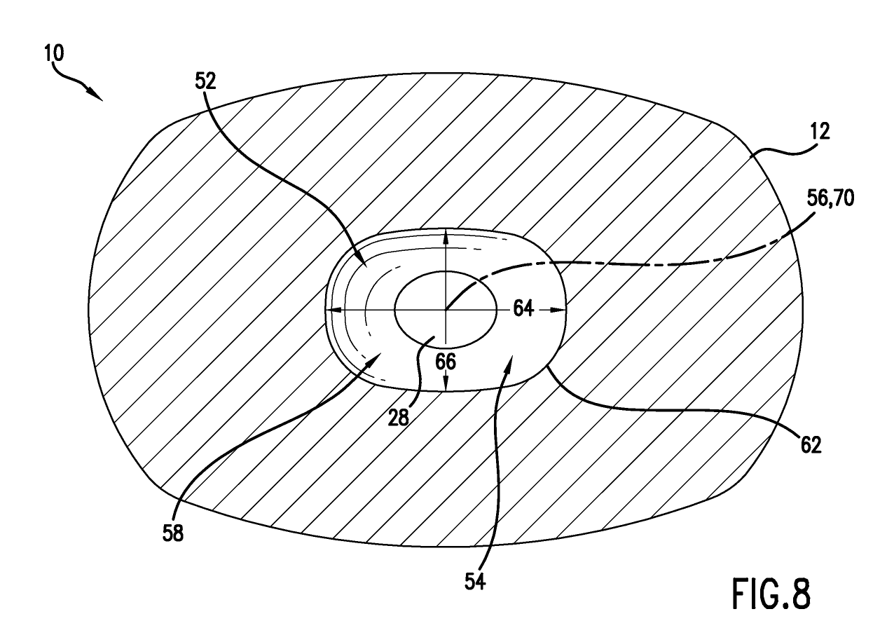

The cup 52 may be arranged so that its perimeter 62 is oval shaped at all points along the longitudinal axis 56 in which the major axis 64 and minor axis 66 intersect the longitudinal axis 56. In other words, the cup 52 may have an oval cross-sectional shape upon view of planes of the cup 52 sliced perpendicular to the longitudinal axis 56. FIG. 8 shows another cross-sectional view of the mouthpiece 10 taken at a point in the upper section 12 of the cup downward from the cross-section of FIG. 7 along the longitudinal axis 56. The intersection of the major axis 64 and the minor axis 66 is disclosed as being a point of intersection B 70 on the longitudinal axis 56. The perimeter 62 of the cup 52 again has an oval shape. The major axis 64 and minor axis 66 can be configured as those previously described and a repeat of this information is not necessary. However, the major axis 64 in FIG. 8 is smaller than the major axis 64 in FIG. 7 because the cup 52 decreases in size downward along the longitudinal axis 56.

Likewise, the minor axis 66 in FIG. 8 is smaller than the minor axis 66 in FIG. 7 because again the cup 52 in the disclosed embodiment has decreased in size upon location along the longitudinal axis 56.

Although only two cross-sections and two points of intersection 68 and 70 are shown, it is to be understood that at all points of intersection along the longitudinal axis 56 in the upper section 58 of the cup 52, the perimeter 62 can have an oval shape. Further, although described as decreasing in size upon moving downward along the longitudinal axis 56, the size of the perimeter 62 need not change. For example, the size and configuration of the perimeter 62 along with the major axis 64 and minor axis 66 at point of intersection B 70 may be the exact same size and configuration as the perimeter 62, major axis 64 and minor axis 66 at the point of intersection A 68. The shape may be the shape of an oval in certain embodiments. The size and configuration of the cup 52 may be the same along any portion of the longitudinal length, or for the entire longitudinal length, of the upper section 58 of the cup 52. In other embodiments, the size of the cup 52 may change at all points upon extending in the longitudinal direction along the longitudinal axis 56. The shape of the perimeter 62 may be the same at all points upon extending in the longitudinal direction along the longitudinal axis 56, or the shape of perimeter 62 may change at these different locations in accordance with other exemplary embodiments of the mouthpiece 10.

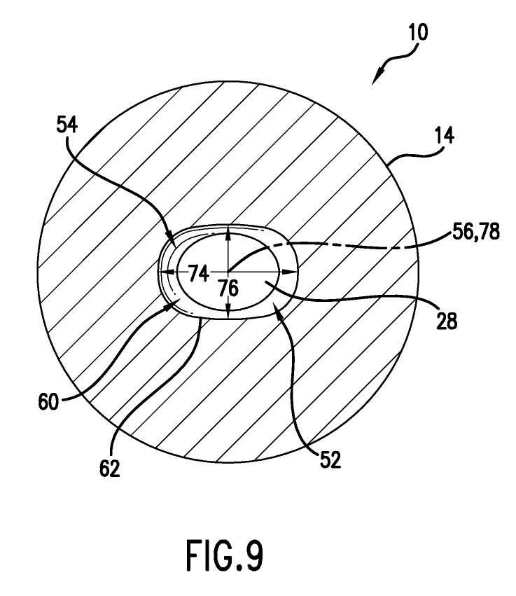

The configuration of the cup 52 in the lower section 60 may be arranged in a similar manner as the cup 52 in the upper section 58. FIG. 9 shows the perimeter 62 of the cup 52 in the lower section 60. The major axis 74 and minor axis 76 intersect one another at a point of intersection C 78 on the longitudinal axis 56. The perimeter 62 in the lower section 60 can be variously shaped. The major axis 74 may be coincident with the major axis 24 along a portion of its length, and the minor axis 76 may be coincident with the minor axis 26 along a portion of its length. Both the major axis 74 and the minor axis 76 extend through the longitudinal axis 56 of the mouthpiece 10 at point of intersection C 78 and are located at a right angle to one another. The major axis 74 may be sized so that it is longer than the minor axis 76. The major axis 74 may be from 1.25 times, 1.5 times, 1.75 times, 2 times, or up to 10 times longer than the minor axis 76. The perimeter 62 can be arranged so that all of the sides of the perimeter 62 are curved. Alternatively, some of the sides may be curved and the others straight, and still further, all of the sides of the perimeter 62 may be straight in accordance with other exemplary embodiments. The perimeter 62 may be arranged so that it is oval in shape. In some embodiments, the perimeter 62 may be an oval in shape and may also be elliptical in shape. In other exemplary embodiments, the perimeter 62 may be square or rectangular in shape. In yet other arrangements, the perimeter 62 in the lower section 60 may be circular in shape.

The size and configuration of the perimeter 62, major axis 64, and minor axis 66 may be the same or different along all points extending through the longitudinal axis 56 along the entire lower section 60. Further, the size and configuration of the perimeter 62, major axis 64, and minor axis 66 may be the same along all points extending through the longitudinal axis 56 along the entire lower section 60 and upper section 58 in accordance with various exemplary embodiments.

The cup 52 may terminate at a throat 72 that can be shaped and sized the same as the perimeter 62 of the cup 52 at the throat 72, or differently than the perimeter 62 at the throat 72. For example, the perimeter 62 at the bottom of the lower section 60 may be in the shape of an oval, and the throat 72 immediately adjacent the bottom of the lower section 60 may be circular in shape. A sharp boundary line may thus be observed between these two features of the mouthpiece 10. In other arrangements, these two openings may be sized and configured so that they transition gradually into one another.

The lower section 16 of the mouthpiece 10 features a shank and a backbore 28 that extends from the throat 72 to the bottom end of the lower section 16. As such, a through bore is defined through the entire mouthpiece 10 along the longitudinal axis 56. The backbore 28 may be circular in shape and can have the same size along its entire longitudinal length, or may inclined such that its size increases in the longitudinal direction away from the throat 72 and towards the lower end of the lower section 16.

The mouthpiece 10 may have an exterior side wall 82 that defines various features. A cosmetic outer surface 30 may be defined at the middle section 14. In some embodiments, the cosmetic outer surface 30 marks the location of the middle section 14 of the mouthpiece 10. In other arrangements, the cosmetic outer surface 30 is not present. The exterior side wall 82 at the upper section 12 can have rounds that extend in the longitudinal direction and may have an oval perimeter such that the upper section 12 has an exterior surface that is oval shaped. The exterior side wall 82 can be variously arranged so that the external cosmetic or functional features of the mouthpiece 10 are shaped and provided differently in accordance with different exemplary embodiments. The exterior side wall 82 in the upper section 12, middle section 14 and/or lower section 16 may be provided differently from that as disclosed in the figures, and it is to be understood that the disclosed arrangement of the exterior side wall 82 in the figures is only exemplary.

The mouthpiece 10 may be provided with one or all of the aforementioned features. Some of the previously discussed features such as the concave end face 20, the oval shaped outer perimeter 22, and/or the oval shaped cup 52 perimeter 62 may allow the resulting mouthpiece 10 to be easier to use by the musician and may reduce the practice time needed by the musician. The musician will be able to reach higher notes through the use of one or more of the aforementioned features. The mouthpiece 10 that includes one or more of the features mentioned herein is more comfortable for the user and imparts less fatigue on the embouchure when playing the instrument.

The mouthpiece 10 may be used with any type of musical instrument. The mouthpiece 10 can be used in connection with a brass instrument such as a trumpet, cornet, piccolo trumpet, flugelhorn, French horn, trombone, euphonium, tenor, alto or double horn, baritone, or tuba. In use, the musician may curl in his or her bottom lip and leave the top lip relaxed. The user may place his or her lips onto the end face 20 and then buzz. As the embouchure increases, the musician will allow his or her lower lip to follow the upper lip in a kiss format while blowing (buzzing). The user may continue to buzz while playing the instrument. The mouthpiece 10 may allow the user to reach high notes even if he or she does not have the necessary natural embouchure to do so with other mouthpieces. The mouthpiece 10 may have features, such as an oval outer perimeter 22 and/or an oval inner perimeter 40, that more closely follow the natural form of the user's lips.

In other uses of the mouthpiece 10, the user could use a standard technique to play the instrument. In this regard, the user may curl in his or her top and bottom lips and buzz with them placed against the end face 20. The user may use one third of the upper lip and two thirds of the bottom lip while playing. The user may maintain a tense or firm upper lip to reach higher notes when using the mouthpiece 10 with a standard technique.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

What is claimed:

1. A mouthpiece for a musical instrument, comprising:
an upper section, wherein a cup is at least partially defined by the upper section, wherein the upper section has a rim that has an end face, wherein the rim has an outer perimeter that has a major axis and a minor axis, wherein the major axis of the outer perimeter of the rim is greater in length than the minor axis of the outer perimeter of the rim.

2. The mouthpiece as set forth in claim 1, further comprising:
a lower section, wherein a backbore is at least partially defined by the lower section; and
a middle section contiguous with the lower section, wherein the upper section is contiguous with the middle section, wherein the middle section has a cosmetic outer surface.

3. The mouthpiece as set forth in claim 1, wherein the outer perimeter of the rim is oval shaped.

4. The mouthpiece as set forth in claim 1, wherein the outer perimeter of the rim has a first major axis side and an oppositely located second major axis side such that the major axis extends from the first major axis side to the second major axis side, wherein the end face is concave in shape upon extending from the first major axis side to the second major axis side.

5. The mouthpiece as set forth in claim 1, wherein the rim has an inner perimeter that has a major axis and a minor axis, wherein the major axis of the inner perimeter of the rim is greater in length than the minor axis of the inner perimeter of the rim, wherein the inner perimeter of the rim is oval shaped.

6. The mouthpiece as set forth in claim 1, wherein the rim has an inner perimeter that has a round, wherein the outer perimeter of the rim has a round, wherein the width of the end face of the rim from the round of the outer perimeter of the rim to the round of the inner perimeter of the rim is flat.

7. The mouthpiece as set forth in claim 1, wherein the upper section has an inner surface that at least partially defines the cup, wherein a longitudinal axis of the mouthpiece extends through the cup, wherein the cup has an upper section and a lower section, wherein a perimeter of the cup at the upper section of the cup has a major axis and a minor axis such that at all points along the longitudinal axis through which both the major axis of the perimeter of the cup at the upper section of the cup and the minor axis of the perimeter of the cup at the upper section of the cup intersect the major axis is longer than the minor axis.

8. A mouthpiece for a musical instrument, comprising:
an upper section, wherein the upper section has an inner surface that at least partially defines a cup, wherein a longitudinal axis of the mouthpiece extends through the cup, wherein the cup has an upper section, wherein a perimeter of the cup at the upper section of the cup has a major axis and a minor axis such that at all points along the longitudinal axis through which both the major axis of the perimeter of the cup at the upper section of the cup and the minor axis of the perimeter of the cup at the upper section of the cup intersect the major axis is longer than the minor axis.

9. The mouthpiece as set forth in claim 8, wherein at all points along the longitudinal axis through which both the major axis of the perimeter of the cup at the upper section of the cup and the minor axis of the perimeter of the cup at the upper section of the cup intersect the perimeter of the cup is oval shaped that surrounds such point of intersection.

10. The mouthpiece as set forth in claim 8, wherein the cup has a lower section that terminates at a throat and that is adjacent the upper section of the cup, wherein a perimeter of the cup at the lower section of the cup has a major axis and a minor axis such that at all points along the longitudinal axis through which both the major axis of the perimeter of the cup at the lower section of the cup and the minor axis of the perimeter of the cup at the lower section of the cup intersect the major axis is longer than the minor axis.

11. The mouthpiece as set forth in claim 10, wherein at all points along the longitudinal axis through which both the major axis of the perimeter of the cup at the upper section of the cup and the minor axis of the perimeter of the cup at the upper section of the cup intersect the perimeter of the cup is oval shaped that surrounds such point of intersection; and
wherein at all points along the longitudinal axis through which both the major axis of the perimeter of the cup at the lower section of the cup and the minor axis of the perimeter of the cup at the lower section of the cup intersect the perimeter of the cup is oval shaped that surrounds such point of intersection.

12. The mouthpiece as set forth in claim 8, wherein the upper section has a rim that has an end face, wherein the rim has an outer perimeter that has a major axis and a minor axis, wherein the major axis of the outer perimeter of the rim is greater in length than the minor axis of the outer perimeter of the rim;
wherein the rim has an inner perimeter that has a major axis and a minor axis, wherein the major axis of the inner perimeter of the rim is greater in length than the minor axis of the inner perimeter of the rim, wherein the inner perimeter of the rim is oval shaped;
wherein an upper end of the cup has a perimeter that is located at the same location as the inner perimeter of the rim so as to be coincident with the inner perimeter of the rim and is oval shaped; and
wherein a round is located at the perimeter of the cup at the upper end of the cup.

13. The mouthpiece as set forth in claim 8, wherein the upper section has a rim that has an end face, wherein the rim has an outer perimeter that has a major axis and a minor axis, wherein the major axis of the outer perimeter of the rim is greater in length than the minor axis of the outer perimeter of the rim;
wherein the outer perimeter of the rim has a first major axis side and an oppositely located second major axis side such that the major axis extends from the first major axis side to the second major axis side, wherein the end face is concave in shape upon extending from the first major axis side to the second major axis side.

14. The mouthpiece as set forth in claim 8, wherein the upper section has a rim that has an end face, wherein the rim has an outer perimeter that has a major axis and a minor axis, wherein the major axis of the outer perimeter of the rim is greater in length than the minor axis of the outer perimeter of the rim;
wherein the rim has an inner perimeter that has a round, wherein the outer perimeter of the rim has a round, wherein the width of the end face of the rim from the round of the outer perimeter of the rim to the round of the inner perimeter of the rim is flat.

15. A mouthpiece for a musical instrument, comprising:
an upper section, wherein a cup is at least partially defined by the upper section, wherein the upper section has a rim that has an end face, wherein at least a portion of the end face is concave in shape.

16. The mouthpiece as set forth in claim 15, wherein the rim has an outer perimeter that has a major axis and a minor axis, wherein the major axis of the outer perimeter of the rim is greater in length than the minor axis of the outer perimeter of the rim, wherein the outer perimeter of the rim has a first major axis side and an oppositely located second major axis side such that the major axis extends from the first major axis side to the second major axis side, wherein the end face is concave in shape upon extending from the first major axis side to the second major axis side.

17. The mouthpiece as set forth in claim 16, wherein the entire outer perimeter of the rim has a round, wherein the end face is concave in shape upon extending from the round of the first major axis side to the round of the second major axis side.

18. The mouthpiece as set forth in claim 17, wherein the rim has an inner perimeter that has a major axis and a minor axis, wherein the major axis of the inner perimeter of the rim is greater in length than the minor axis of the inner perimeter of the rim, wherein the inner perimeter of the rim is oval shaped;
wherein the outer perimeter of the rim is oval shaped.

19. The mouthpiece as set forth in claim 18, further comprising:
a lower section, wherein a backbore is at least partially defined by the lower section; and
a middle section contiguous with the lower section, wherein the upper section is contiguous with the middle section, wherein the middle section has a cosmetic outer surface;
wherein a longitudinal axis of the mouthpiece extends through the cup and the backbore, wherein the cup has an upper section, wherein a perimeter of the cup at the upper section of the cup has a major axis and a minor axis such that at all points along the longitudinal axis through which both the major axis of the perimeter of the cup at the upper section of the cup and the minor axis of the perimeter of the cup at the upper section of the cup intersect the major axis is longer than the minor axis;
wherein at all points along the longitudinal axis through which both the major axis of the perimeter of the cup at the upper section of the cup and the minor axis of the perimeter of the cup at the upper section of the cup intersect the perimeter of the cup is oval shaped that surrounds such point of intersection.
